(19) United States
(12) Patent Application Publication
(10) Pub. No.: US 2025/0146597 A1
(43) Pub. Date: May 8, 2025

(54) PILOT OPERATED SHUTTLE VALVE

(71) Applicant: KOHLER CO., Kohler, WI (US)

(72) Inventors: Andrew Smith, Sheboygan, WI (US); Clay Garrels, Sheboygan, WI (US)

(21) Appl. No.: 18/928,724

(22) Filed: Oct. 28, 2024

Related U.S. Application Data
(60) Provisional application No. 63/597,066, filed on Nov. 8, 2023.

(51) Int. Cl. F16K 31/40

(52) U.S. Cl. CPC F16K 31/40

(57) ABSTRACT

An actuation assembly is provided herein that may include a pilot operated shuttle valve. The shuttle valve may rotate a rotation portion of the actuation assembly. When the rotation portion is rotated, different output sources may be opened and/or closed. The shuttle valve may include a shuttle may open and/or close a plurality of outputs. The shuttle may be attached to a plurality of springs, one of which may extend and/or compress based on temperature. When extended and/or compressed, the shuttle may translate within a shuttle pathway to open and/or close the plurality of outputs.

### CROSS-REFERENCE TO RELATED APPLICATION

The present application claims priority to U.S. Provisional Patent Application No. 63/597,066, filed Nov. 8, 2023, entitled, “PILOT OPERATED SHUTTLE VALVE,” the entire contents of which are hereby incorporated by reference.

### BACKGROUND

Shuttle valves are used in several industries to control the fluid flow within an actuation assembly. Such shuttle valves may be operated manually or by pressure being applied to springs within the shuttle valve. When pressure is applied, the shuttle valve may translate in a direction to open and/or close outputs of the actuation assembly.

### BRIEF DESCRIPTION OF DRAWINGS

FIG. 1 is a front cross-sectional view of a first example pilot operated shuttle valve in a first position.

FIG. 2 is a perspective cross-sectional view of the first example pilot operated shuttle valve in the first position.

FIG. 3 is a perspective cross-sectional view of the first example pilot operated shuttle valve in a second position.

FIG. 4 is a front cross-sectional view of a second example pilot operated shuttle valve in a first position.

FIG. 5 is a front cross-sectional view of the second example pilot operated shuttle valve in a second position.

FIG. 6 is a front cross-sectional view of the second example pilot operated shuttle valve in a third position.

FIG. 7 is a perspective view of a first example actuation assembly.

FIG. 8 is a perspective view of the first example actuation assembly.

FIG. 9 is an enlarged perspective view of the first example actuation assembly in a first position.

FIG. 10 is an enlarged perspective view of the first example actuation assembly in a second position.

FIG. 11 is a perspective view of a second example actuation assembly.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

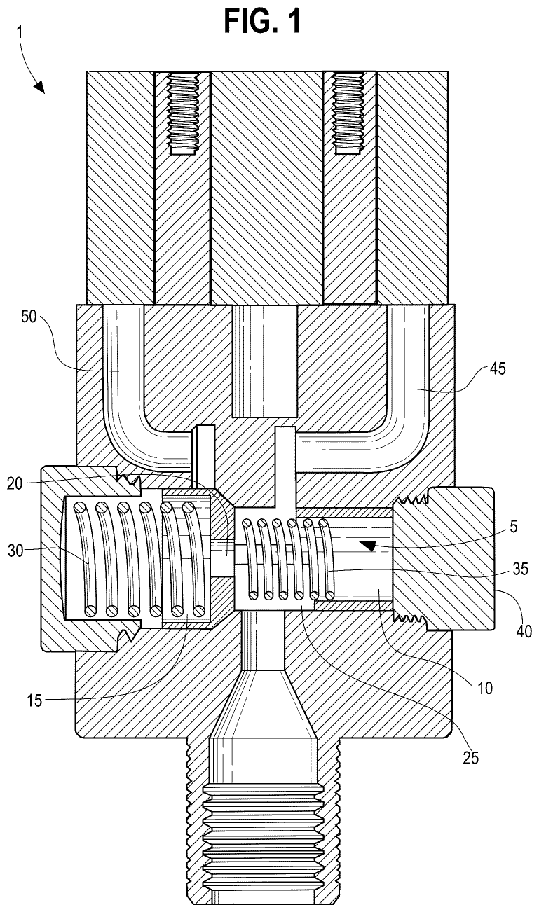

Turning first to FIGS. 1-3, a pilot operated shuttle valve assembly 1 may include a first shuttle 5, which may be a horizontal shuttle 5. The horizontal shuttle 5 may include a first body portion 10 and a second body portion 15. The first body portion 10 and second body portion 15 may be connected to one another via a connection mechanism 20. The horizontal shuttle 5 may translate linearly within a shuttle pathway 25, which may be latitudinally with respect to a direction of water flow. Such orientation of the horizontal shuttle 5 may form a compact, small overall size of the pilot operated shuttle valve assembly 1. The horizontal shuttle 5 may be removable from the pilot operated shuttle valve assembly 1 (e.g., it may be removed for maintenance).

The horizontal shuttle 5 may be attached to a first spring 30 and a second spring 35. The first spring 30 may be attached to an inner portion of the second body portion 15. The second spring 35 may be placed on a side of the second body portion 15 opposite the first spring 30. The first spring 30 may be a tension spring which may bias the horizontal shuttle 5 toward a first end 40. The first spring 30 may be a standard stainless steel helical spring, or any other spring. The second spring 35 may be formed from a shape memory allow (SMA), which may be temperature dependent. The second spring 35 may extend or compress based on the temperature of the second spring 35, and thereby based on the temperature of the flowing fluid. Alternatively, the second spring 35 may assume different configurations based on the presence or absence of applied electricity. The second spring 35 may be a Nitinol SMA spring. The positioning of the second spring 35 (within the primary path of fluid flow) may enable more efficient temperature transfer as compared to a spring that is located outside of the primary path of fluid flow. Alternatively, the first spring 30 may be an SMA spring, and the second spring 35 may be a standard spring, or the first spring 30 and the second spring 35 may both be SMA springs. The first spring 30 and the second spring 35 may adjust based on a predetermined pressure or applied force.

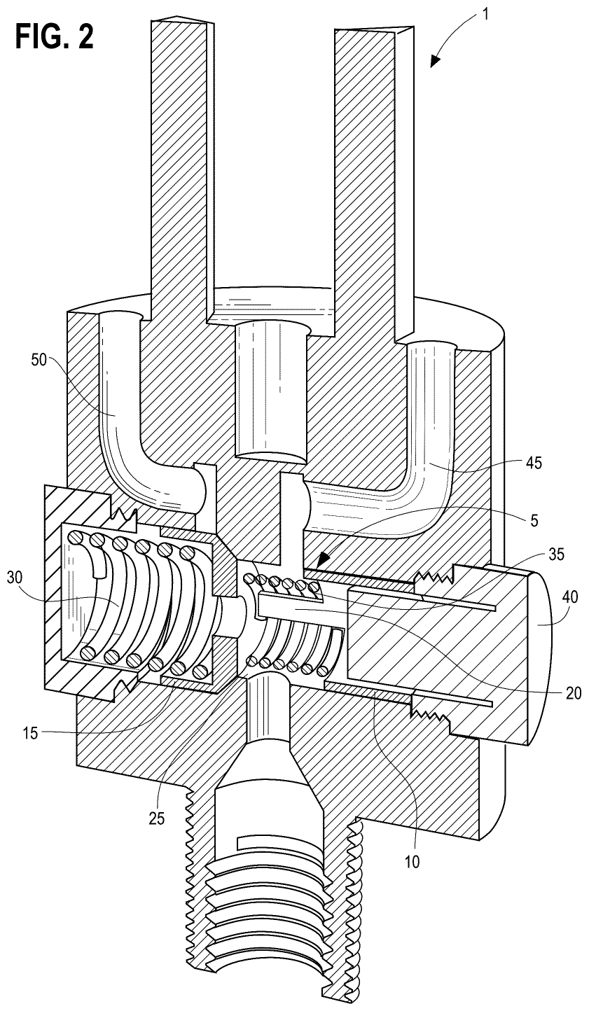

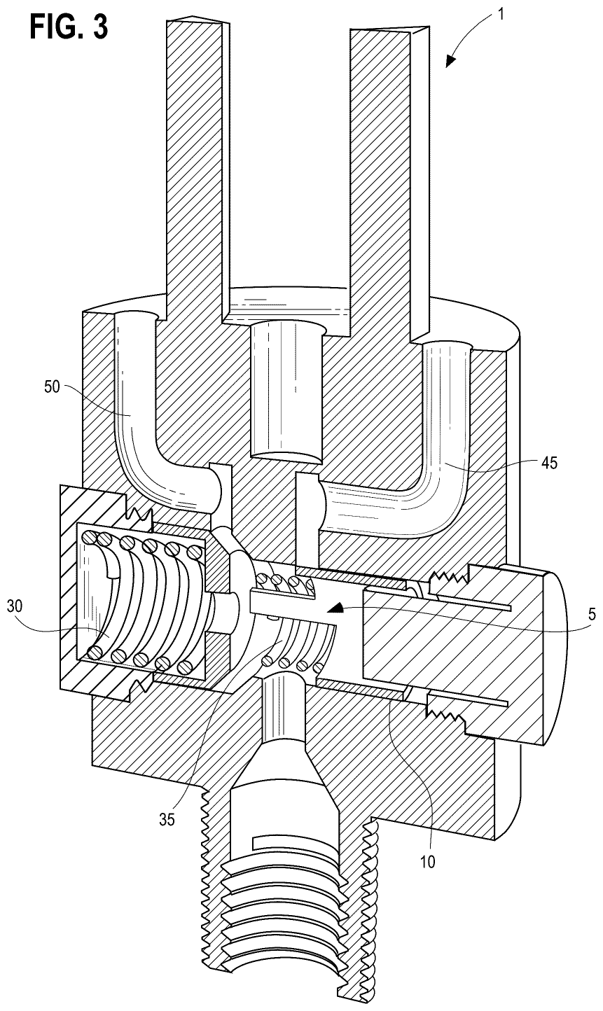

As illustrated in FIGS. 1 and 2, when the fluid passing into the shuttle valve assembly 1 is of a first temperature, the second spring 35 may react by assuming a first configuration in which it is compressed, such that first spring 30 biases the horizontal shuttle 5 to its first position opening the first output line 45 and closing the second output line 50. The second body portion 15 may cover and close the second output line 50. As illustrated in FIG. 3, when the fluid passing into the shuttle valve assembly 1 is of a second temperature, the second spring 35 may react by assuming its second configuration, in which it is extended more than its first configuration in FIGS. 1 and 2, such that it overcomes the biasing of the first spring 30 and closes the first output line 45 while opening the second output line 50. The first body portion 10 of the horizontal shuttle 5 may cover and close the first output line 45.

In some embodiments, the second spring 35 may have additional positions. As a non-limiting example, in a third position, the second spring 35 is compressed more than its configuration in FIGS. 1 and 2, such that both the first output line 45 and the second output line 50 are opened. Further positions and further outputs may also be included. The horizontal shuttle 5 of the shuttle valve assembly 1 may be long enough such that the first body portion 10 and the second body portion 15 may close both the first output line 45 and second output line 50 at one time. In such configuration, the second spring 35 may extend in order to open one of the first output line 45 or the second output line 50.

The pilot operated shuttle valve assembly 1 may include threaded plugs attached to the first spring 30 and/or the second spring 35. The threaded plugs may adjust tension on the first spring 30 and/or the second spring 35. When the springs 30, 35 are temperature-dependent springs, the threaded plugs may be used to adjust the tension on the springs 30, 35 to dial in a specific temperature that may activate the first spring 30 and/or the second spring 35. When the springs 30, 35 are springs which adjust their configurations based on the presence or absence of applied electricity, the threaded plugs may be used to adjust the tension on the springs 30, 35 to affect the amount of movement of the first spring 30 and/or the second spring 35 at a given voltage or current. The threaded plugs may be used to adjust the current or voltage to achieve a desired action.

The fluid flowing out of the first output line 45 and the second output line 50 may be used for any desired purpose. Each output line 45, 50 may flow independently from the other. Each output line 45, 50 may feed into different or the same devices. The pilot operated shuttle valve assembly 1 may be connected to one or more of an actuation assembly, fluidic actuator, piston, hydraulic cylinder, turbine, or any other assembly that creates motion or energy from fluid flow or pressure. As such, the pilot operated shuttle valve assembly 1 may control the flow of fluid into or through a device.

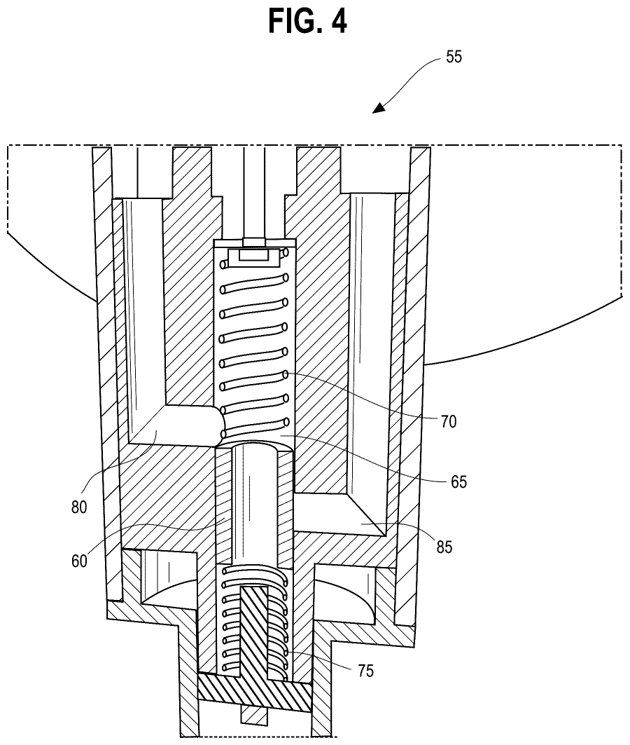

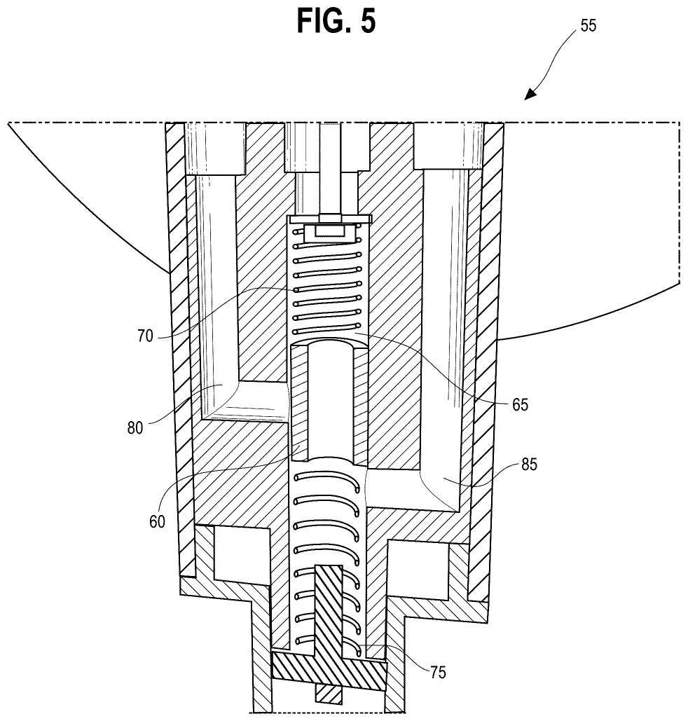

Turning now to FIGS. 4 and 5, a pilot operated shuttle valve assembly 55 may include a vertical shuttle 60. The vertical shuttle 60 may translate longitudinally within a shuttle pathway 65 with respect to a direction of water flow. The vertical shuttle 60 may be attached to a first spring 70 and a second spring 75. The first spring 70 may be a tension spring used to bias the vertical shuttle 60 in a downward direction. The first spring 70 may be a standard stainless steel helical spring, or any other spring. The second spring 75 may be formed from a shape memory allow (SMA), which may be temperature dependent. The second spring 75 may extend or compress based on the temperature of the second spring 75, and thereby based on the temperature of the flowing fluid. Alternatively, the second spring 75 may assume different configurations based on the presence or absence of applied electricity. The second spring 75 may be a Nitinol SMA spring. Alternatively, the first spring 70 may be an SMA spring, and the second spring 75 may be a standard spring, or the first spring 70 and the second spring 75 may both be SMA springs. The first spring 70 and the second spring 75 may adjust based on a predetermined pressure or applied force.

As illustrated in FIG. 4, when the fluid passing into the shuttle valve assembly 55 is of a first temperature, the second spring 75 may react by assuming a first configuration in which it is compressed, such that first spring 70 biases the vertical shuttle 60 to its first position opening the first output line 80 and closing the second output line 85. As illustrated in FIG. 5, when the fluid passing into the shuttle valve assembly 55 is of a second temperature, the second spring 75 may react by assuming its second configuration, in which it is extended more than its first configuration in FIG. 4, such that it overcomes the biasing of the first spring 70 and closes the first output line 80 while opening the second output line 85. In some embodiments, the second spring 75 may have additional positions. As a non-limiting example, in a third position, the second spring 75 is extended more than its configuration in FIG. 5, such that both the first output line 80 and the second output line 85 are opened. Further positions and further outputs may also be included.

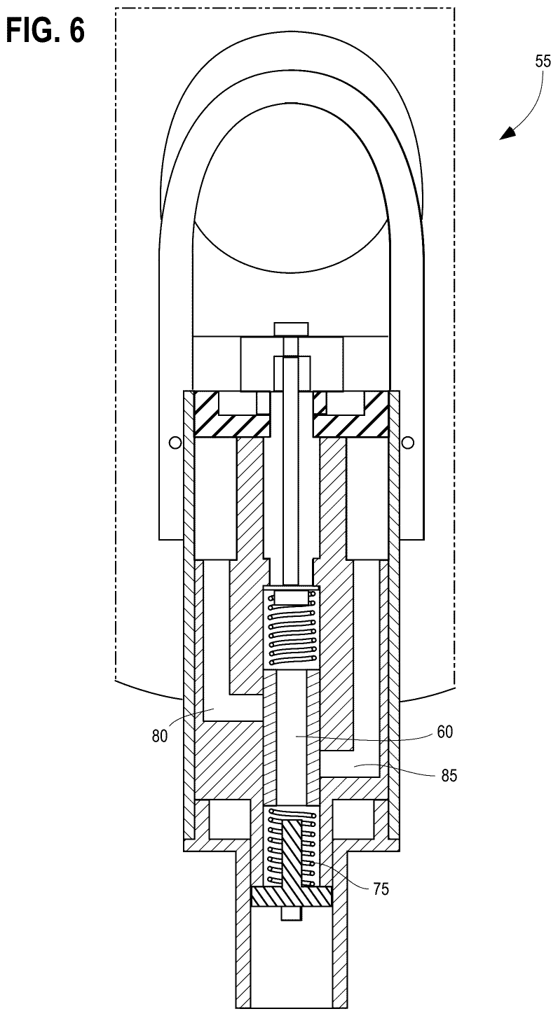

According to FIG. 6, the vertical shuttle 60 of the shuttle valve assembly 55 may be long enough to close both the first output line 80 and second output line 85 at one time. In such configuration, the second spring 75 may extend in order to open one of the first output line 80 or the second output line 85.

The pilot operated shuttle valve assembly 1 or 55 may be paired with a plurality of hydraulic actuators (e.g., a rotor vane or a hydraulic cylinder). Although the pilot operated shuttle valve assembly 1 or 55 may be integrated with the hydraulic actuators in a single device, the pilot operated shuttle valve assembly 1 or 55 may be connected fluidically to hydraulic actuators that may be in different locations than the pilot operated shuttle valve assembly 1 or 55. The hydraulic actuators may each be in different locations from one another, and the pilot operated shuttle valve assembly 1 or 55 may be in a different location than each of the hydraulic actuators. Additionally, the hydraulic actuators may be attached to varying devices, and a single pilot operated shuttle valve assembly 1 or 55 may be used to control each of the devices. As discussed above, the pilot operated shuttle valve assembly 1 or 55 may be connected to one or more of an actuation assembly, fluidic actuator, piston, hydraulic cylinder, turbine, or any other assembly that creates motion or energy from fluid flow or pressure. When connected, the pilot operated shuttle valve assembly 1 or 55 may be connected to multiple actuators and devices and may aid in achieving a low energy control and actuation system. Such connections may form a programmable actuation system which may utilize a low amount of energy (including approximately zero), as such system may operate on the fluid flowing through the system.

For example, the pilot operated shuttle valve assembly 1 or 55 may be connected to three hydraulic actuators. Following along with such example, one of such actuators may be attached to a flush valve; one, to a toilet seat opening; and one, to a shower door closing. The pilot operated shuttle valve assembly 1 or 55 may flush a toilet via the first actuator, to open a toilet seat via the second actuator, and to close a shower door via the third actuator. The foregoing example is not to be construed as limiting, as the pilot operated shuttle valve assembly 1 or 55 may be connected to any number of hydraulic actuators which may be connected to any number of devices.

The pilot operated shuttle valve assembly 1 or 55 may control a plurality of fluid channels (i.e., inputs and outputs). The channels may be opened and/or closed by controlling at least one of the length, the shape, and the movement of the horizontal shuttle 5 within the shuttle pathway 25. The pilot operated shuttle valve assembly 1 or 55 may be connected to any number of other pilot operate shuttle valve assemblies in series or in parallel. When connected, the assemblies may operate in conjunction with one another to complete a series of actions or to create logic within an assembly system.

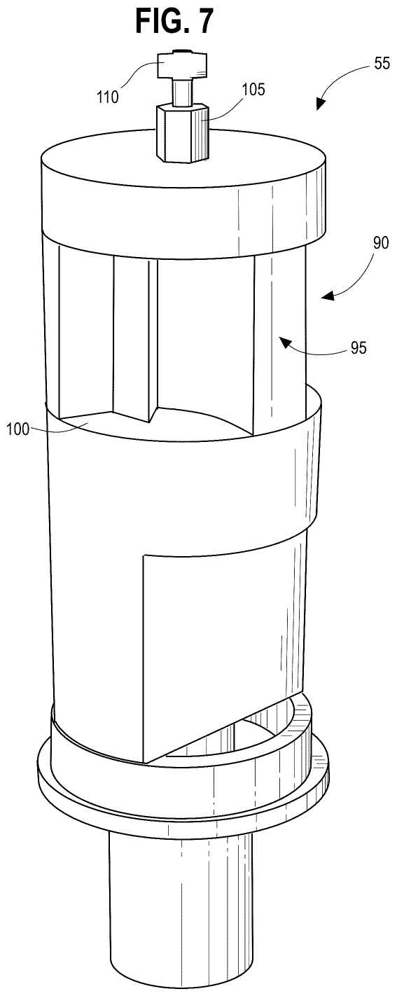

As a non-limiting example, turning now to FIG. 7, the pilot operated shuttle valve assembly 1 or 55 may be connected to an actuation assembly 90. The actuation assembly 90 and its corresponding components may be made from any suitable material, including plastic or metal. The shuttle valve assembly 55 may rotate a rotation portion 95 within a cylindrical portion 100 of the actuation assembly 90. Actuation of the pilot operated shuttle valve assembly 55 may result in rotation the rotation portion 95. The rotation portion 95 may rotate within a range of motion of ⅛ inch, or any other range. A top portion 105 of the rotation portion 95 may be attached to an actuator control 110, whereby when the top portion 105 rotates so too does the actuator control 110. The actuator control 110 may be coupled to any number of devices to control such devices.

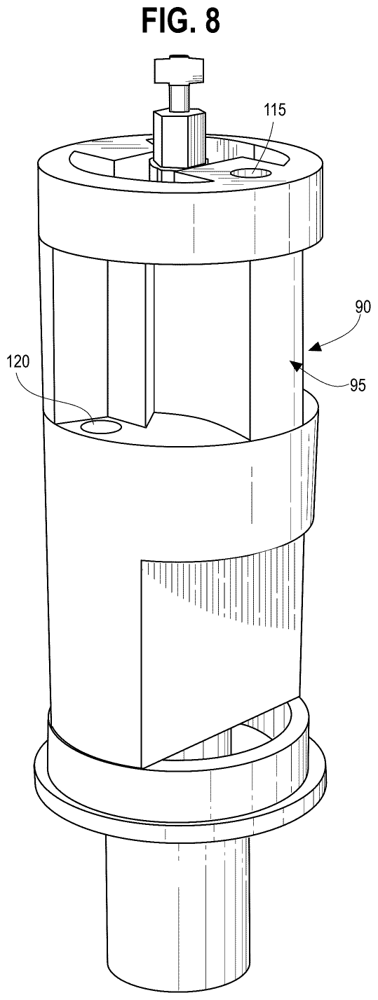

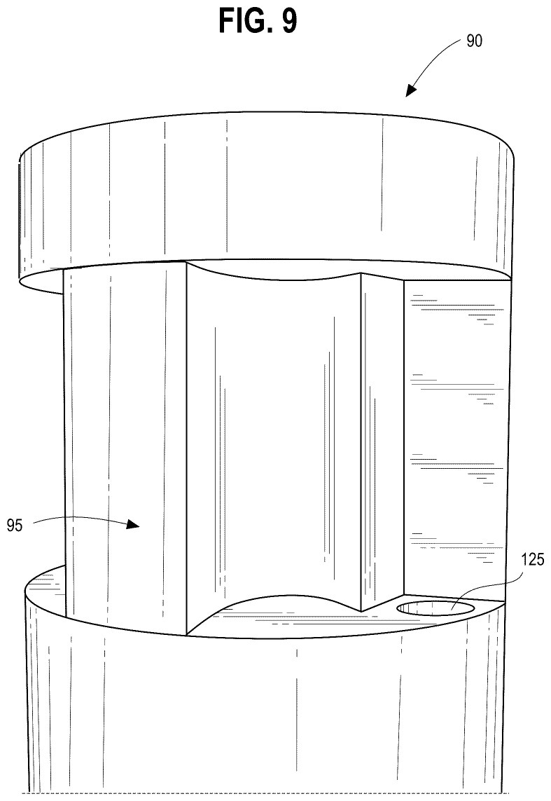

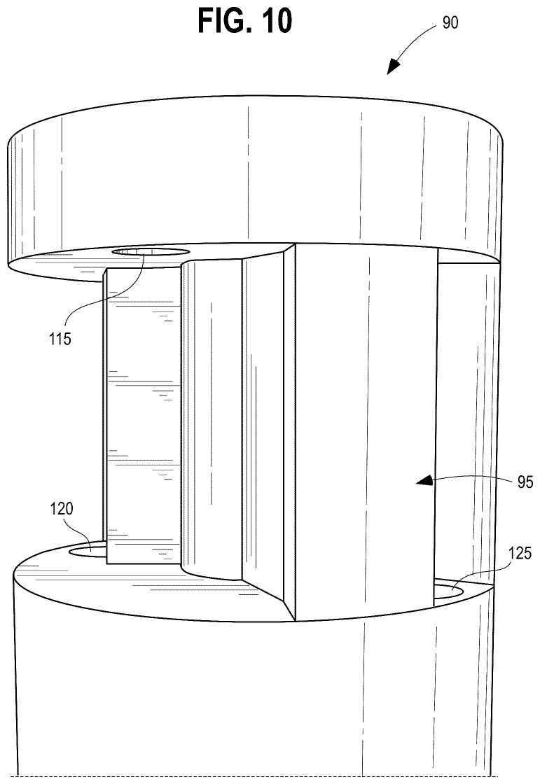

As illustrated in FIG. 8, the actuation assembly 90 may include a single output source 115. Rotation of the rotation portion 95 may cause the output source 115 to be opened and/or closed, such that fluid from at least one of input sources 120, 125 may flow out of the output source 115. Input sources 120, 125 may be connected to the output lines 80, 85, as discussed with reference to FIGS. 4-6. Input sources 120, 125 may be fed with at least one of hot and cold water. Other feeds may also be used. According to FIGS. 8 and 9, the rotation portion 95 may be rotated, such that the output source 115 is closed and is covered by the rotation portion 95. In such a configuration, fluid from the input sources 120, 125 is prevented from exiting the output source 115, and no fluid flows through the output source 115. In FIG. 10, the rotation portion 95 of the actuation assembly 90 may be rotated, such that output source 115 is opened to input source 120 but closed to input source 125. When the output source 115 is open, fluid from the input source 120 may flow through the output source 115. The same may be true of input source 125 flowing to output source 115, with movement of the rotation portion 95 in the opposite direction.

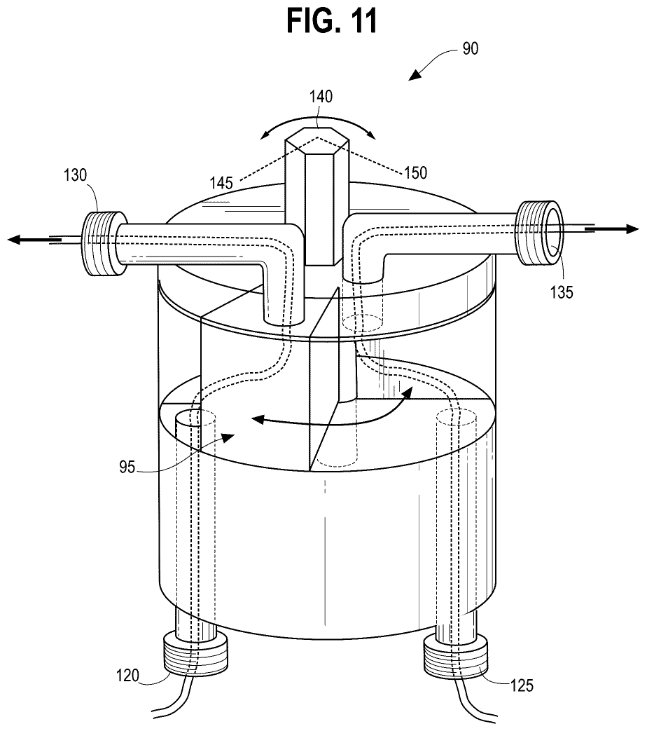

Turning now to FIG. 11, the actuation assembly 90 may include input sources 120, 125 and output sources 130, 135. Although FIG. 11 only shows two input sources 120, 125 and two output sources 130, 135, there may be any number of input sources and output sources. The rotation portion 95 of the actuation assembly 90 may rotate from a central position 140 to a first position 145 or a second position 150.

As illustrated in FIG. 11, when the actuation assembly 90 is in the central position 140, the output source 130 and output source 135 may both be at least partially blocked. By at least partially blocking both output sources 130, 135, the flow of fluid may be stopped in the case of full blockage, or may both be partially opened in the case of partial blockage, resulting in lowered throughput of both. In the first position 145, the output source 130 may be blocked, while the output source 135 is open. And in the second position 150, the output source 130 may be open while the output source 135 is blocked. When one of the output sources 130, 135 is opened, fluid from a corresponding input source 120, 125 flows out through the corresponding output source 130, 135. The rotation portion 95 may separate the fluid from the input sources 120, 125. As such, the input source 120 corresponds to the output source 130, while the input source 125 corresponds to the output source 135. When the rotation portion 95 is rotated to open the output source 130, the fluid from the input source 120 flows out of the output source 130. When the rotation portion 95 is rotated to open the output source 135, the fluid from the input source 125 flows out of the output source 135.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A pilot operated shuttle valve assembly comprising:
a shuttle valve comprising:
a shuttle;
a shuttle pathway; and
a plurality of springs, wherein at least one of the plurality of springs is a shape memory alloy (SMA) spring which adjusts in shape based on at least one of pressure, temperature, or force;
a plurality of inputs for providing fluid to the shuttle valve; and
a plurality of outputs for the fluid from at least one of the plurality of inputs to exit at least one of the plurality of outputs.

2. The pilot operated shuttle valve assembly of claim 1, wherein the shuttle valve is attached to an actuation assembly, and wherein the shuttle valve rotates a rotation portion of the actuation assembly.

3. The pilot operated shuttle valve assembly of claim 1, wherein based on the position of the shuttle valve, each of the plurality of outputs is opened or closed.

4. The pilot operated shuttle valve assembly of claim 1, wherein when the shuttle valve is in a first position, a first output of the plurality of outputs is open, and a second output of the plurality of outputs is closed.

5. The pilot operated shuttle valve assembly of claim 1, wherein when the shuttle valve is in a second position, a first output of the plurality of outputs is closed, and a second output of the plurality of outputs is open.

6. The pilot operated shuttle valve assembly of claim 1, wherein the plurality of springs includes a tension spring biasing the shuttle valve to a first position.

7. The pilot operated shuttle valve assembly of claim 1, wherein the shuttle valve translates within the shuttle pathway based on adjustment in shape of the SMA spring, and wherein the adjustment in shape of the SMA spring is at least one of extension or compression.

8. The pilot operated shuttle valve assembly of claim 1, wherein fluid provided via the plurality of inputs causes the SMA spring to adjust in shape.

9. A pilot operated shuttle valve comprising:
a shuttle pathway;
a shuttle that translates within the shuttle pathway; and
at least one shape memory alloy (SMA) spring which adjusts in shape based on at least one of pressure, temperature, or force applied to the SMA spring by a fluid flowing to the pilot operated shuttle valve via a plurality of inputs;
wherein the adjustment in shape of the SMA spring causes at least one of:
a first output of the plurality of outputs to adjust from an open position to a closed position; or
a first output of the plurality of outputs to adjust from a closed position to an open position.

10. The pilot operated shuttle valve of claim 9, wherein when at least one of the plurality of outputs is open, fluid from the plurality of inputs flows out the at least one of the plurality of outputs.

11. The pilot operated shuttle valve of claim 9, wherein adjustment in shape of the SMA spring causes the shuttle to translate within the shuttle pathway, and wherein the adjustment in shape of the SMA spring is at least one of extension or compression.

12. The pilot operated shuttle valve of claim 11, wherein the shuttle translates from a first position to a second position within the shuttle pathway.

13. The pilot operated shuttle valve of claim 12, further comprising a tension spring biasing the shuttle valve to a first position.

14. The pilot operated shuttle valve of claim 9, wherein the shuttle valve is attached to an actuation assembly, and wherein the shuttle valve rotates a rotation portion of the actuation assembly.

15. The pilot operated shuttle valve of claim 9, wherein when the shuttle valve is in a first position, a first output of the plurality of outputs is open, and a second output of the plurality of outputs is closed.

16. The pilot operated shuttle valve of claim 9, wherein when the shuttle valve is in a second position, a first output of the plurality of outputs is closed, and a second output of the plurality of outputs is open.

17. A pilot operated shuttle valve assembly comprising:
a shuttle valve comprising:
a shuttle pathway;
a shuttle that translates within the shuttle pathway;
a tension spring biasing the shuttle to a first position; and
a shape memory alloy (SMA) spring which adjusts in shape based on at least one of pressure, temperature, or force applied to the SMA spring by a fluid flowing to the pilot operated shuttle valve via a plurality of inputs.

18. The pilot operated shuttle valve assembly of claim 17, wherein the adjustment in shape of the SMA spring causes at least one of:
a first output of the plurality of outputs to adjust from an open position to a closed position; or
a first output of the plurality of outputs to adjust from a closed position to an open position.

19. The pilot operated shuttle valve assembly of claim 17, wherein the adjustment in shape of the SMA spring causes the shuttle to translate within the shuttle pathway, and wherein the adjustment in shape of the SMA spring is at least one of extension or compression.

20. The pilot operated shuttle valve assembly of claim 18, wherein when the shuttle valve is in a first position, a first output of the plurality of outputs is open, and a second output of the plurality of outputs is closed.
